(19) United States
(12) Patent Application Publication
(10) Pub. No.: US 2019/0284800 A1
(43) Pub. Date: Sep. 19, 2019

(54) TUNED DYNAMIC DAMPER AND METHOD FOR REDUCING THE AMPLITUDE OF OSCILLATIONS

(71) Applicant: SOLETANCHE FREYSSINET, Rueil-Malmaison (FR)

(72) Inventor: Charles CYNOBER, Issy-les-Moulineaux (FR)

(73) Assignee: SOLETANCHE FREYSSINET, Rueil-Malmaison (FR)

(21) Appl. No.: 16/465,771

(22) PCT Filed: Nov. 30, 2017
(86) PCT No.: PCT/EP2017/081069

§ 371 Date: May 31, 2019

(30) Foreign Application Priority Data
Dec. 2, 2016 (FR) 1661862

(51) Int. Cl. E04B 1/98

(52) U.S. Cl. CPC E04B 1/985; F16F 7/1022

(57) ABSTRACT

A pendular tuned mass damper includes a set of hangers connected in an articulated manner to a fixed frame, a mobile frame carried by the hangers, at least one inertial mass carried by the fixed frame or the mobile frame, and a system for driving the inertial mass, the system configured to transform variation of the angle of at least one hanger relative to the fixed frame or to the mobile frame into a relative movement of the inertial mass with respect to the frame that carries it.

The present invention concerns a tuned mass damper (TMD).

Such dampers are used to attenuate the vibrations of a structure in a restricted range of frequencies around the resonant frequency of the structure. These systems function on the principle of cycles of transfers between kinetic energy and potential energy and dissipation, in particular viscous dissipation, of the kinetic energy in each cycle.

The principle was initially applied to reduce the oscillations of a ship in U.S. Pat. No. 989,958 to H. Frahm in 1909.

Since then a great number of dampers have been proposed.

Some, such as that disclosed in the publication CN 205153175, employ a first inertial mass mobile in translation and a second inertial mass mobile in rotation about a fixed rotation axis and the rotation movement of which is driven by a rack moving with the first inertial mass. Such dampers are limited to damping vertical vibrations.

There was proposed in the publication CN 203034632 a damper comprising a flywheel fitted with pinions mobile in rotation on a double rack between which the flywheel moves. The movement along the rack of the flywheel is therefore accompanied by rotation of the latter on itself, which enables the kinetic energy to be increased by accumulation of the so-called “translation” kinetic energy linked to the movement along the rack and the kinetic energy of rotation of the flywheel on itself. This damper is limited to damping unidirectional vibrations.

So-called “pendular” dampers are also known.

Such dampers comprise an oscillation damping system and an inertial mass connected by hangers to a fixed frame connected to the structure the vibrations of which are to be damped.

Examples of pendular dampers are described in CN204458973U, CN 103132628A, CN202954450U.

US 2013/0326969 discloses a pendular damper in which the pendular movement of the inertial mass is damped by means of induced current electromagnetic brakes in order to generate electricity. The hangers are connected to the fixed frame by articulations configured to cause the armature disks subjected to a magnetic field to turn. The armature disks are of very low inertia and make a negligible contribution to the accumulation of rotational kinetic energy compared to the kinetic energy generated by the mass effecting the pendular movement.

In high towers in particular, where the usable floor area is expensive, a compromise has to be found between the effectiveness of the damper and its volume.

EP 474 269 discloses a mass damper comprising an inertial mass supported by two parallel rods that drive it in movement parallel to itself, with no rotation on itself relative to the frame. To increase the kinetic energy the mass has to be increased, with the disadvantage of having to reinforce the rods mechanically, which increases the cost and the overall size of the damper.

Other dampers are disclosed in JP 2000-74135, DE 10 2007 024 431 and U.S. Pat. No. 5,005,326.

The present invention aims to improve further tuned mass dampers and more particularly pendular dampers.

The invention achieves this by means of a pendular tuned mass damper comprising.
a set of hangers to be connected in an articulated manner to a fixed frame,
a mobile frame carried by the hangers,
at least one inertial mass carried by the mobile frame or by the fixed frame,
a system for driving the inertial mass configured to convert a variation of the angle of at least one hanger relative to the mobile frame or to the fixed frame into a relative movement of the inertial mass with respect to the frame that carries it.

The relative movement of the inertial mass with respect to the frame that carries it is preferably a movement of rotation on itself.

The invention makes it possible to increase the overall kinetic energy by adding to the kinetic energy linked to the movement of the pendulum that of the movement of the inertial mass relative to the frame that carries it, notably that of rotation of the inertial mass on itself.

By increasing the rotation speed, it is possible to increase the rotational kinetic energy without having to increase the mass and the overall size of the damper.

The orientation of the inertial mass relative to the frame may change over time relative to the frame because of its rotation on itself. The inertial mass may turn on itself through more than 180°, better still more than 360° about its own rotation axis during the operation of the damper. The inertial mass is preferably carried by the mobile frame.

It is therefore possible to reduce the weight of the inertial mass without reducing the overall kinetic energy relative to an inertial mass fixed with respect to the mobile frame and to reduce the weight of the pendulum, which in particular facilitates its installation at the top of a high tower.

The driving system advantageously comprises a demultiplier mechanism. A small angular variation of the hangers can therefore be converted into a significant movement of rotation of the inertial mass on itself.

The driving system may comprise a driving gear guided in rotation relative to the mobile frame and to which a hanger is attached. This driving gear may mesh with a driven gear guided in rotation by the mobile frame and turning with the inertial mass.

Alternatively, the driving system comprises at least one rack. The latter is for example attached at its ends to hangers. The driving system may comprise a pinion turning with the inertial mass and meshing with the rack.

In one embodiment the damper comprises a pinion meshing with the rack and driving the inertial mass by way of a suitable mechanism, in particular bevel gearing, the inertial mass preferably having a vertical rotation axis when the damper is at rest.

The damper may in particular comprise two parallel racks and a pair of pinions meshing with those racks and coupled to the same inertial mass drive shaft.

In another embodiment, the mobile frame comprises a first chassis and a second chassis, the hangers being attached to the first chassis and being coupled to the second chassis so that angular movement of the hangers relative to the vertical is accompanied by movement of the second chassis relative to the first. The inertial mass is connected to the two chassis so that the relative movement of the two chassis with respect to one another is accompanied by movement in rotation of the inertial mass relative to the two chassis. The inertial mass may be connected to the two chassis by ball joints.

Movements of the inertial mass and of the mobile frame may be damped in various ways, aiming or not aiming to recover kinetic energy to produce electricity.

In one embodiment of the invention, the tuned mass damper comprises one or more viscous dampers that may be disposed in various manners depending on the structure of the damper. For example, the aforementioned upper and lower chassis may be connected by viscous dampers.

In embodiments of the invention the tuned mass damper comprises at least one friction or induction brake.

The damper may be unidirectional but is preferably bidirectional. It may comprise at least two inertial masses that turn about respective mutually perpendicular rotation axes or alternatively axes that are coaxial and oriented vertically when the damper is at rest.

In variant embodiments the tuned mass damper comprises four flywheels, the diametrically opposite flywheels turning about parallel rotation axes.

The weight of the inertial mass may be such that the ratio of the nominal kinetic energy of the inertial mass in rotation on itself to the nominal kinetic energy in translation is between 0.4 and 100, better still between 0.4 and 10.

The tuned mass damper is normally designed to operate with relatively frequent wind, seismic and other loads in respect of which the aim is to maintain a given level of comfort, or even to maintain a stress level below a certain limit. In the case of high towers, the tuned mass damper may come up against the stops because of exceptional wind, seismic or other conditions, which are rare. By “nominal” is meant under the normal conditions of use of the damper, that is to say between the minimum and maximum operating loads. The maximum load may correspond to a limit load before coming to abut against a system protecting against accidental loads.

A ratio between 0.4 and 10 is preferred for high masses, typically greater than 10³ kg.

The inertial mass may have a weight greater than or equal to 10² kg, better still 5·10² kg, even better still 10³ kg.

Another aspect of the invention consists in a civil engineering structure, in particular a tower or a footbridge, equipped with a damper according to the invention as defined above.

The invention further consists in a method for reducing the amplitude of the oscillations of a civil engineering structure, in particular a tower or a footbridge, using a damper as defined hereinabove, in which the mobile frame is allowed to oscillate in a pendular manner so as to reduce the amplitude of the oscillations of the structure.

The invention will be better understood on reading the following detailed description of nonlimiting embodiments of the invention and examining the appended drawings, in which:

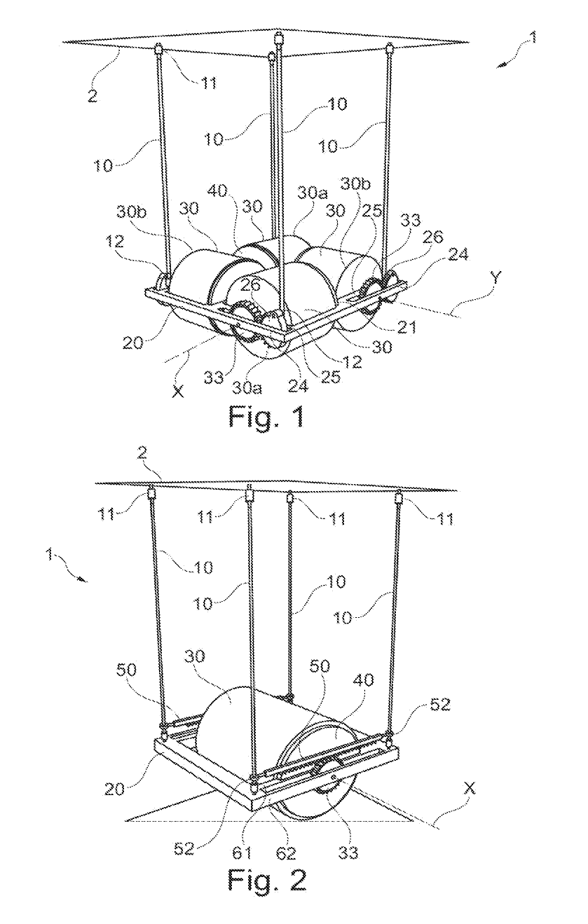

FIG. 1 is a diagrammatic partial perspective view of one example of a tuned mass damper according to the invention,

FIGS. 2 to 4 are views analogous to FIG. 1 of variant embodiments,

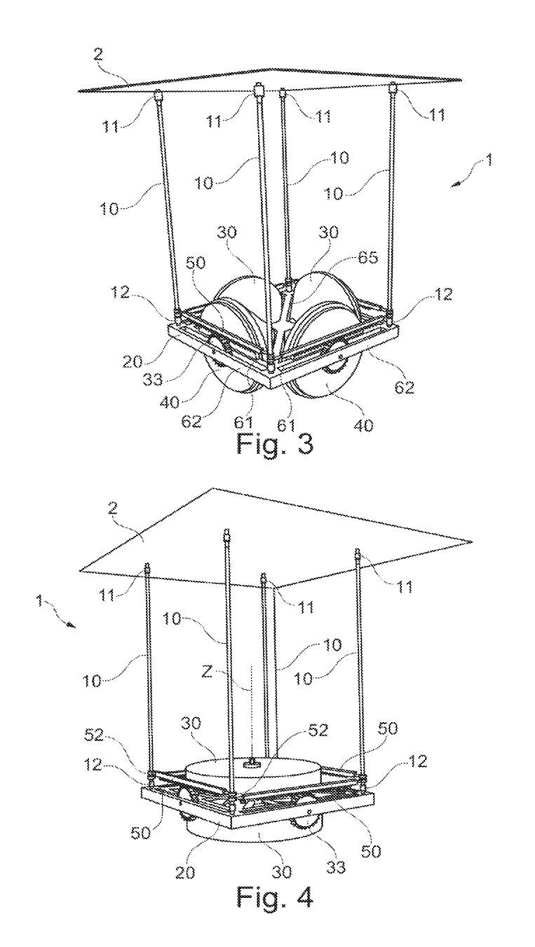

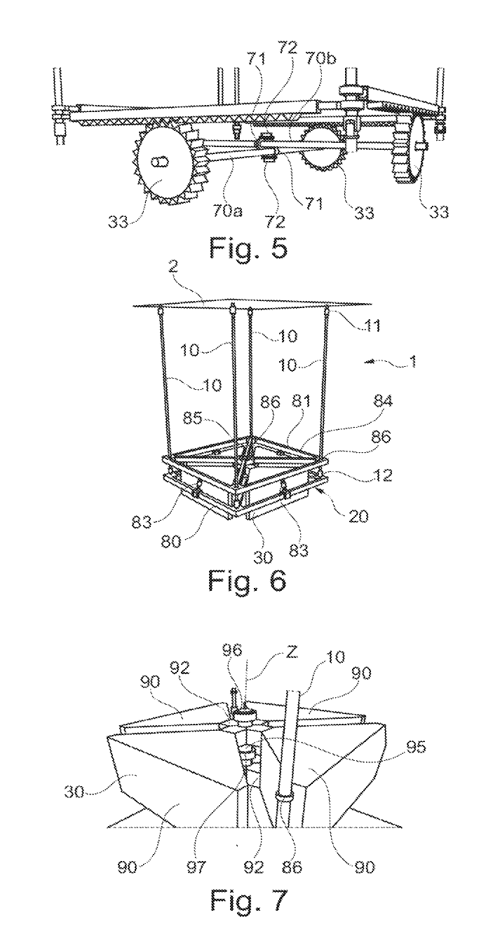

FIG. 5 shows a detail of the system for driving the flywheels of the damper from FIG. 4,

FIG. 6 is a view analogous to FIG. 1 of another variant embodiment, and

FIG. 7 shows a structural detail of the damper from FIG. 6.

There is shown in FIG. 1 a tuned mass damper 1 according to the invention comprising a set of hangers 10, four in number in the example considered here.

The hangers 10 are attached in an articulated manner at their upper end 11 to a fixed frame 2 of the structure equipped with the damper, for example a high tower comprising apartments and/or offices. They support at their lower end 12 a mobile frame 20 that carries four inertial masses 30 in the form of flywheels each able to turn on itself relative to the mobile frame 20.

In the example considered here, the damper 1 comprises two diametrically opposite flywheels 30a turning about parallel rotation axes X and two other and also diametrically opposite flywheels 30b turning about parallel rotation axes Y perpendicular to the axis X.

The mobile frame 20 comprises beams 21 that extend between the flywheels 30 and support bearings guiding rotation of shafts that turn with the corresponding flywheels 30.

In the example considered here, each shaft on which a corresponding flywheel is mounted to rotate on the frame 20 carries a pinion 33.

Each of the hangers 10 is connected at its lower end 12 to a toothed wheel 26, the articulation of the hanger to that wheel being eccentric relative to the rotation axis of the wheel. Each toothed wheel 26 meshes with a corresponding pinion 33.

Pendular oscillation of the mobile frame 20 with the flywheel 30 is therefore accompanied by a variation of the angle of the longitudinal axis of the hangers 10 relative to the mobile frame 20 and rotation of one or more of the flywheels 26 relative to the frame 20. This rotation drives that of the corresponding flywheel via the pinion 33 that meshes with the wheel 26.

Oscillation of the damper is therefore accompanied by rotation of the flywheels 30 and accumulation of rotational kinetic energy in addition to that linked to the pendular oscillation movement.

The wheels 26 and the corresponding pinions 33 may be produced so as to obtain a demultiplication factor greater than 1 in order to increase the rotation speed of the flywheels and the rotational kinetic energy.

Each flywheel 30 may be associated, as shown, with viscous type means for braking its rotation, that is to say exerting a braking torque proportional to the rotation speed. For example, as shown, each flywheel is associated with an induction brake disk 40.

In the variant shown in FIG. 2, the mobile frame 20 carries a single inertial mass 30 in the form of a flywheel turning about a rotation axis X.

The flywheel 30 turns with two pinions 33 disposed at its axial ends and each of which meshes with a corresponding rack 50 extending between two hangers 10 and coupled to the latter by means of attachments 52.

Pendular oscillation of the damper 1 in a plane perpendicular to the axis X is therefore accompanied by variation of the angle of the hangers 10 relative to the mobile frame and movement of the racks 50 relative to the frame, which causes rotation of the flywheel 30 about the axis X.

The flywheel 30 may be equipped with a brake disk, for example an inductive or friction brake disk, to dissipate the rotational kinetic energy.

The mobile frame 20 may be produced with two spaced parallel beams 61 and 62 on respective opposite sides of the flywheel 30 between which the corresponding pinion 33 is disposed.

The example from FIG. 2 is unidirectional.

The variant from FIG. 3 is bidirectional, comprising a mobile frame 20 comprising a framework inside which are disposed four inertial masses 30 in the form of flywheels each associated with a pinion 33 and a rack 50, the latter being disposed along respective sides of the framework of the mobile frame 20. As shown here, the latter may comprise two beams 65 in a cruciform arrangement joined at their center and connected to respective corners of the framework of the frame 20.

As shown here, each flywheel 30 may have a generally frustoconical shape converging toward the center of the frame 20. Each flywheel 30 may be equipped with a brake 40, for example an inductive or friction brake.

In the variant embodiment shown in FIG. 4, the damper 1 comprises two flywheels 30 that are coaxial and turn about a rotation axis Z that is vertical when the damper is at rest.

As in the embodiment from FIG. 3, the system driving the flywheels 30 comprises four racks 50 each of which connects two adjacent hangers 10, being coupled thereto, so that oscillation of the mobile frame 20 is accompanied by movement of the racks 50 parallel to the corresponding sides of the frame 20.

The movement of the racks 50 is transmitted to the flywheel 30 by pinions 33. Two opposite gears are connected by a shaft 70a and the other two by another shaft 70b crossing the first one. The pinions 33 are guided in rotation by the frame 20 and turn with the shafts 70a and 70b, as can be seen in FIG. 5. Each shaft 70a or 70b carries a corresponding bevel gear 71 that meshes with a bevel gear 72 turning with the corresponding flywheel 30 so that rotation of the pinions 33 on themselves is accompanied by rotation of the corresponding flywheel 30 about the rotation axis Z.

The tuned mass damper 1 from FIG. 4 is therefore bidirectional.

There has been shown in FIGS. 6 and 7 a variant embodiment of the tuned mass damper 1 with no gears for demultiplying the angular movement of the hangers 10 relative to the mobile frame 20.

In this embodiment, the mobile frame 20 comprises a lower chassis 80 and an upper chassis 81 of similar shape comprising an exterior framework of polygonal, in this instance square, shape and an X-shape structure with two beams 85 crossing at their center 86 and connected at their ends to the corners of the framework 84.

The two chassis 80 and 81 are interconnected by viscous dampers 83 that are disposed for example at the mid-length of the sides of each chassis.

The lower end 12 of each hanger 10 is connected in an articulated manner to the lower chassis 80 and passes through a corresponding opening 86 in the upper chassis 81 with a small clearance.

During pendular oscillation of the mobile frame 20, the variation of the angle of the hangers relative to the lower chassis 80 is therefore accompanied by movement of the upper chassis 81 relative to the lower chassis 80. The central parts 86 of the two chassis 80 and 81 therefore have a distance between their axes that varies during oscillation of the mobile frame 20.

The tuned mass damper 1 comprises a single inertial mass 30 that comprises four blocks 90 of pyramidal general shape converging toward the center, connected by two vertically spaced crosses 92. The crosses 92 are connected by a shaft 95 with vertical axis Z when the damper 1 is at rest. The shaft 95 comprises ball joints 97 engaged in the respective central parts 86 of the upper chassis 81 and the lower chassis 80.

Relative movement of the upper chassis 81 with respect to the lower chassis 80 is therefore accompanied by tilting of the shaft 95 and rotation of the blocks 90. The latter are inscribed in the triangles formed by the X-shape structures of the upper and lower chassis.

Of course, the invention is not limited to the examples that have just been described.

In particular it is possible to produce differently the inertial mass and the mechanism enabling transmission of the variation of the angle of a hanger relative to the vertical to the inertial mass to cause it to turn on itself.

The expression “comprising a” must be understood as synonymous with “comprising at least one”, unless otherwise specified. The expression “between” means comprising the limits.

1. A pendular tuned mass damper comprising:
a set of hangers connected in an articulated manner to a fixed frame,
a mobile frame carried by the hangers,
at least one inertial mass carried by the fixed frame or by the mobile frame, and
a system for driving the inertial mass, configured to transform variation of the angle of at least one hanger relative to the fixed frame or to the mobile frame into a relative movement of rotation on itself of the inertial mass with respect to the frame that carries it.

2. The tuned mass damper according to claim 1, wherein the relative movement of the inertial mass with respect to the frame that carries it being a movement of rotation on itself of the inertial mass about its own axis by more than 180.

3. The tuned mass damper according to claim 1, wherein the inertial mass is carried by the mobile frame.

4. The tuned mass damper according to claim 1, wherein the driving system comprises a demultiplier mechanism.

5. The tuned mass damper according to claim 1, wherein the driving system comprises a driving gear guided in rotation relative to the mobile frame and to which a hanger is attached.

6. The tuned mass damper according to claim 5, wherein the driving gear meshes with a driven gear guided in rotation by the mobile frame and turning with the inertial mass.

7. The tuned mass damper according to claim 1, wherein the driving system comprises at least one rack.

8. The tuned mass damper according to claim 7, wherein the rack is attached at its ends to hangers.

9. The tuned mass damper according to claim 7, further comprising a pinion turning with the inertial mass and meshing with the rack.

10. The tuned mass damper according to claim 7, further comprising a pinion meshing with the rack and driving the internal mass by means of an appropriate mechanism.

11. The tuned mass damper according to claim 10, further comprising two parallel racks and a pair of pinions meshing with the two parallel racks and coupled to the same shaft for driving the inertial mass.

12. The tuned mass damper according to claim 11, wherein the mobile frame comprises a first chassis and a second chassis, the hangers are attached to the first chassis and are coupled to the second chassis so that angular movement of the hangers relative to the vertical is accompanied by movement of the second chassis relative to the first chassis, the inertial mass is connected to the two chassis so that the relative movement of the two chassis is accompanied by movement in rotation of the inertial mass relative to the two chassis.

13. The tuned mass damper according to claim 12, wherein the inertial is connected to the two chassis by ball joints.

14. The damper according to claim 12, wherein the two chassis are connected by viscous dampers.

15. The tuned mass damper according to claim 1, wherein the tuned mass damper is unidirectional.

16. The tuned mass damper according to claim 1, wherein the tuned mass damper is bidirectional.

17. The tuned mass damper according to claim 16, further comprising four flywheels turning about parallel rotation axes for the diametrically opposite flywheels.

18. The tuned mass damper according to claim 1, wherein the ratio of the nominal kinetic energy in rotation on itself of the inertial mass to the nominal kinetic energy in translation of the inertial mass being between 0.4 and 100.

19. The tuned mass damper according to claim 1, further comprising at least one induction brake and/or one system for generating electrical energy by slowing the inertial mass.

20. A civil engineering structure equipped with a tuned mass damper according to claim 1.

21. A method for reducing the amplitude of oscillations of a civil engineering structure using a tuned mass damper according to claim 1, in which the mobile frame is allowed to oscillate so as to reduce the amplitude of the oscillations of the structure.

22. The tuned mass damper according to claim 1, wherein the relative movement of the inertial mass with respect to the frame that carries it is a movement of rotation on itself of the inertial mass about its own axis by more than 360°.

23. The tuned mass damper according to claim 10, wherein the inertial mass has a vertical rotation axis when the damper is at rest.

24. The tuned mass damper according to claim 16, further comprising at least two flywheels that turn about respective mutually perpendicular axes or axes that are coaxial and oriented vertically when the damper is at rest.
